(19) United States
(12) Patent Application Publication
(10) Pub. No.: US 2007/0228233 A1
(43) Pub. Date: Oct. 4, 2007

(54) Name Your ToothBrush

(76) Inventors: Hue Lily Vujosevic, Pfluggerville, TX (US); Ranko Vujosevic, Austin, TX (US)

Correspondence Address: HUE LILY VUJOSEVIC, 206 BETTERMAN DRIVE, PFLUGERVILLE, TX, 78660, US

(21) Appl. No.: 11/308,521

(22) Filed: Mar. 31, 2006

(51) Int. Cl. F16M 11/00

(52) U.S. Cl. 248/176.1

(57) ABSTRACT

Perky toothbrush holders are used to hold toothbrushes. They are available in variety of colors with decals, decorative display base with or without aquarium alternate base, and a nameplate area so end-users can personalize their toothbrushes.

### BACKGROUND OF THE INVENTION

Young children tend to forget which toothbrush would belong to them so they would pick or would mix with other family members' toothbrushes. This might spread germs from one family member to the next. The Name Your Toothbrush has the nameplate holder area where young people can personalize their toothbrush the way they want it. The names can be their own names, their favorite animals, etc. The toothbrush holders come in variety of colors with decals, decorative display base with or without aquarium alternate base that might attract young children to reach for their toothbrushes more often.

### BRIEF DESCRIPTION OF THE DRAWINGS

FIG. 1 is a front view.

FIG. 2 is a top view.

FIG. 3 is a left side view (mirror view is right side view).

FIG. 4 is a left side view with alternate aquarium base.

FIG. 5 is a cross section as reference in FIG. 1. Hatching represents a transparent material.

FIG. 6 is a nametag paper.

FIG. 7 is a toothbrush holder with 2 holders.

FIG. 8 is a toothbrush holder with 3 holders.

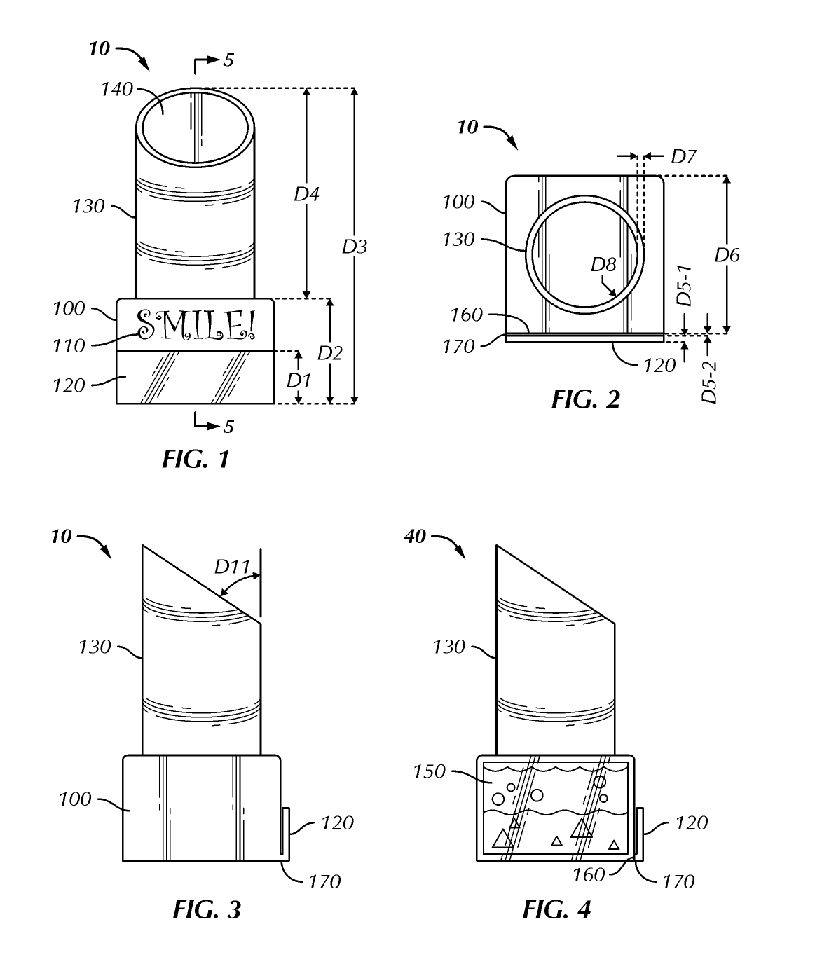

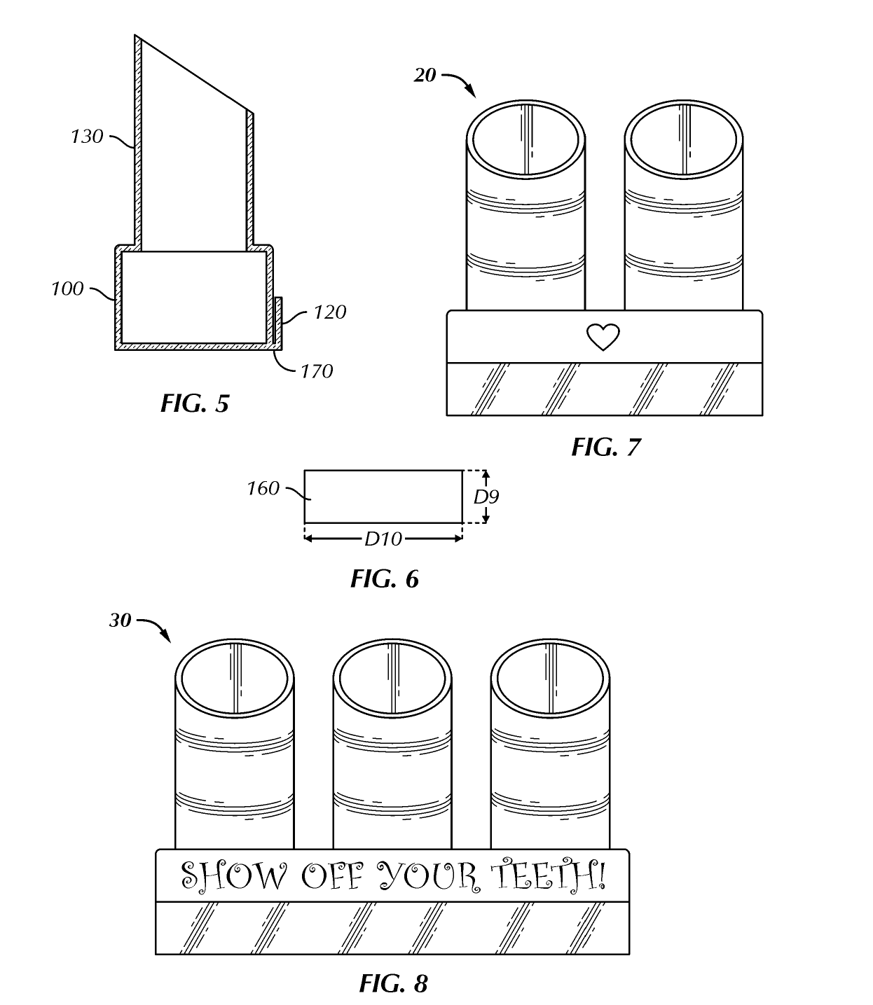

### DETAILED DESCRIPTION OF THE INVENTION

Perky toothbrush holder consists of four major parts: a cylinder, a cylinder opening, colors and decorative base with or without aquarium alternate base, and a nameplate holder. The main embodiment is one piece. The alternate embodiment shows aquarium-style base and option of nameplate being of different material.
10 is the overall toothbrush holder.
20 is the toothbrush holder second embodiment.
30 is the toothbrush holder third embodiment.
40 is the toothbrush holder fourth embodiment.
100 is the base.
110 is the decoration on base (note able to decorate any surface).
120 is the nametag holder.
130 is the cylinder.
140 is the cylinder opening.
150 is an alternate base.
160 adhesive to attach holder 120 to base 100 (optional for 150).
170 is an extension of nametag holder.
D1 preferred height of nametag holder.
D2 preferred height of base.
D3 preferred overall height.
D4 preferred height of cylinder.
D5-1 preferred thickness of nametag holder.
D5-2 preferred opening of extension 170.
D6 preferred width and length of base.
D7 preferred cylinder wall thickness.
D8 preferred cylinder-opening diameter.
D9 preferred nametag height.
D10 preferred nametag width.
D11 preferred angle cut front side cylinder.

What is claimed is:

1. Perky toothbrush holder consists of:
cylinder,
cylinder opening,
colors, decorative base with or without aquarium alternate base, and a nameplate holder.

2. Perky toothbrush holder of claim 1 consists of one cylinder opening.

3. Perky toothbrush holder of claim 1 consists of two cylinder openings.

4. Perky toothbrush holder of claim 1 consists of three cylinder openings.
